(19) United States
(12) Patent Application Publication
(10) Pub. No.: US 2012/0162856 A1
(43) Pub. Date: Jun. 28, 2012

(54) CONDUCTIVE PASTE COMPOSITION FOR TERMINATION ELECTRODE AND MULTILAYER CERAMIC CAPACITOR INCLUDING THE SAME AND MANUFACTURING METHOD THEREOF

(75) Inventors: Kyu Ha LEE, Suwon (KR); Byung Jun JEON, Seoul (KR); Myung Jun PARK, Cheongju (KR); Ji Sook KIM, Seoul (KR); Hyun Hee GU, Yongin (KR); Gun Jung YOON, Seoul (KR); Chang Hoon KIM, Yongin (KR); Eun Joo CHOI, Suwon (KR)

(73) Assignee: SAMSUNG ELECTRO-MECHANICS CO., LTD.

(21) Appl. No.: 13/333,523

(22) Filed: Dec. 21, 2011

(30) Foreign Application Priority Data
Dec. 27, 2010 (KR) 10-2010-0135457

(51) Int. Cl. H01G 4/008; H01B 1/16; B82Y 30/00; B82Y 99/00

(52) U.S. Cl. 361/305; 252/512; 29/25.41; 977/776; 977/948

(57) ABSTRACT

There are provided a conductive paste composition for a termination electrode, and a multilayer ceramic capacitor including the same and a manufacturing method thereof. The conductive paste composition includes 100 parts by weight of conductive metal powder and 0.1 to 10 parts by weight of ceramic powder having an average particle size of 50 to 500 nm. The conductive paste composition described above may achieve a high firing density even in the case that it is used in the manufacturing of a thin film, and inhibit the occurrence of blisters, a delamination failure of the termination electrode during calcination of the electrode, thereby producing a compact and thin film.

### CROSS-REFERENCE TO RELATED APPLICATIONS

This application claims the priority of Korean Patent Application No. 10-2010-0135457 filed on Dec. 27, 2010, in the Korean Intellectual Property Office, the disclosure of which is incorporated herein by reference.

### BACKGROUND OF THE INVENTION

1. Field of the Invention

The present invention relates to a conductive paste composition for a termination electrode, allowing for a high firing density and inhibiting the occurrence of blisters even in the case that it is used in the manufacturing of a thin film, a multilayer ceramic capacitor including the same and a manufacturing method thereof.

2. Description of the Related Art

In general, an electronic component using a ceramic material, such as a capacitor, an inductor, a piezoelectric device, a varistor, a thermistor, or the like, has a ceramic body made of the ceramic material, internal electrodes formed in the ceramic body, and termination electrodes provided on the outer surface of the ceramic body to be electrically connected to the internal electrodes.

Among various ceramic components, a multilayer ceramic capacitor includes a plurality of laminated dielectric layers, internal electrodes arranged on opposite sides of each of the dielectric layers, and termination electrodes electrically connected to the internal electrodes.

The multilayer ceramic capacitor has advantages, for example, small size, high capacity and ease of mounting, thus being widely used as a part of a mobile communications device such as a computer, a PDA, a mobile phone, or the like.

Recently, with the trend toward the development of smaller-sized, higher performance chip parts in response to a reduction in the size of electronic products and the increasing multi-functionality thereof, there has been a requirement for a high capacity multilayer ceramic capacitor having a smaller size and a higher capacity than those of the related art.

In this regard, there have been attempts made to reduce the size of the multilayer ceramic capacitor and to increase the capacity thereof by decreasing the thickness of the termination electrode layer, while maintaining an overall size of the chip without alteration.

However, when the thickness of the termination electrode layer is reduced, densification of an electrode or coverage at a corner part are deteriorated and, defects such as blisters, a delamination failure within the termination electrode, or the like may be caused, thus reducing the reliability of the multilayer ceramic capacitor.

### SUMMARY OF THE INVENTION

An aspect of the present invention provides a conductive paste composition for a termination electrode allowing for a high firing density and capable of inhibiting occurrence of blisters even in the case that it is used in the manufacturing of a thin film, a multilayer ceramic capacitor including the same and a manufacturing method thereof.

According to an aspect of the present invention, there is provided a conductive paste composition for a termination electrode, including: 100 parts by weight of a conductive metal powder; and 0.1 to 10 parts by weight of a ceramic powder having an average particle size of 50 to 500 nm.

The conductive metal powder may be copper (Cu) and an average particle size of the conductive metal powder may range from 0.1 to 4 μM.

The average particle size of the ceramic powder may range from 100 to 200 nm and the content thereof may range from 1 to 5 parts by weight.

According to another aspect of the present invention, there is provided a multilayer ceramic capacitor, including: a ceramic sintered body; a plurality of internal electrodes provided in the ceramic sintered body, which are alternately exposed to both end surfaces of the ceramic sintered body at respective ends of the internal electrodes; and termination electrodes placed on the end surfaces of the ceramic sintered body and electrically connected to the internal electrodes, wherein each of the termination electrodes includes 100 parts by weight of a conductive metal powder and 0.1 to 10 parts by weight of a ceramic powder having an average particle size of 50 to 500 nm.

According to another aspect of the present invention, there is provided a method of manufacturing a multilayer ceramic capacitor, the method including: preparing a plurality of ceramic green sheets; forming internal electrode patterns on the ceramic green sheets; laminating the ceramic green sheets having the internal electrode patterns formed thereon, to thereby form a ceramic laminate; cutting the ceramic laminate to allow the internal electrode patterns to be alternately exposed to the cut surfaces of the ceramic laminate at respective ends of the internal electrode patterns, then, firing the same to thereby produce a ceramic sintered body; forming termination electrode patterns by using a conductive paste composition for termination electrodes which includes 100 parts by weight of a conductive metal powder and 0.1 to 10 parts by weight of a ceramic powder having an average particle size of 50 to 500 nm, such that the termination electrode patterns are electrically connected to the exposed ends of the internal electrode patterns; and sintering the termination electrode patterns to thereby fabricate termination electrodes.

The sintering of the termination electrode patterns may be conducted at 600 to 900° C.

The conductive metal powder may be Cu and an average particle size of the conductive metal powder may range from 0.1 to 4 μm.

The average particle size of the ceramic powder may range from 100 to 200 nm and the content thereof may range from 1 to 5 parts by weight.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view illustrating a conductive paste composition for a termination electrode according to an exemplary embodiment of the present invention;

FIG. 2 is a perspective view illustrating a multilayer ceramic capacitor according to an exemplary embodiment of the present invention;

FIG. 3 is a cross-sectional view taken along line A-A′ shown in FIG. 2;

FIG. 4 illustrates a process of manufacturing a multilayer ceramic capacitor according to an exemplary embodiment of the present invention;

FIG. 5 is electron micrographs showing the analysis results of micro-structures according to inventive examples, as compared to an comparative example; and

FIG. 6 is graphs showing the occurrence of blisters according to inventive examples, as compared to an comparative example.

### DETAILED DESCRIPTION OF THE PREFERRED EMBODIMENT

Hereinafter, exemplary embodiments will be described in detail with reference to the accompanying drawings.

However, other modifications, variations and/or alterations thereof may be possible and the present invention is not particularly limited to the following embodiments. These exemplary embodiments are merely provided to offer a clearer understanding of the present invention to those skilled in the art to which the present invention pertains.

Therefore, the shapes and/or sizes of respective elements shown in the accompanying drawings may be enlarged for clarity and like reference numerals denote elements substantially having the same configurations or performing similar functions and actions throughout the drawings.

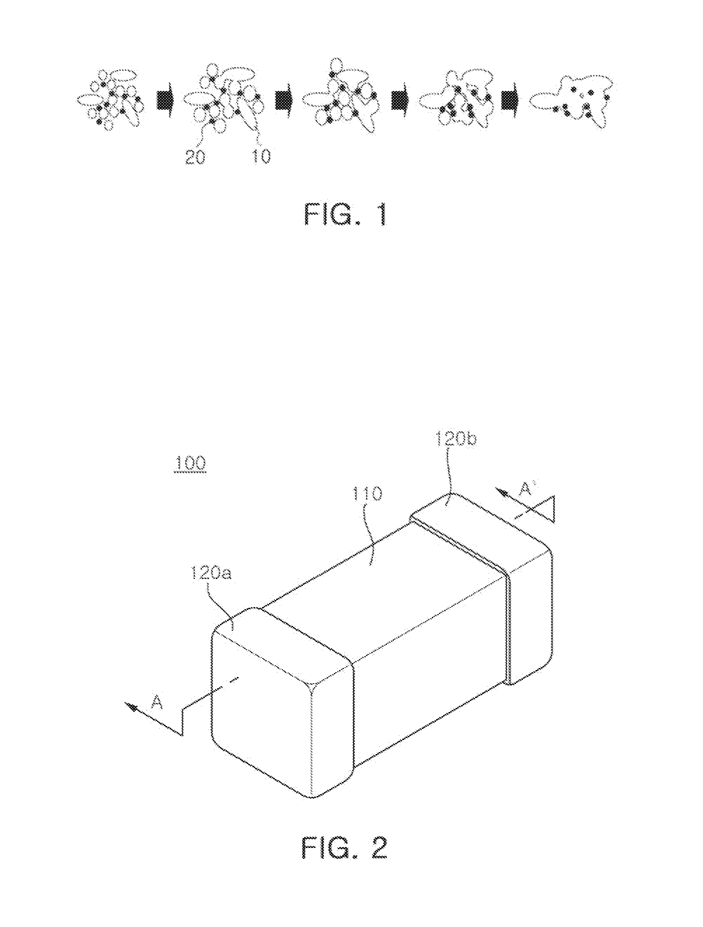

FIG. 1 is a schematic view illustrating a conductive paste composition for a termination electrode according to an exemplary embodiment of the present invention.

Referring to FIG. 1, a conductive paste composition for a termination electrode includes: 100 parts by weight of a conductive metal powder 10; and 0.1 to 50 parts by weight of a ceramic powder having an average particle size of 50 to 500 nm.

The conductive metal powder 10 is not particularly limited so long as it is any conductive metal powder used for a termination electrode, and may include, for example, Cu.

The particle size of the conductive metal powder 10 may be varied according to purposes of the present invention and, for example, range from 0.1 to 4 μM.

According to the exemplary embodiment of the present invention described above, adding the ceramic powder non-reactive with Cu during preparing a paste for a termination electrode may prevent occurrence of blisters.

In general, a Cu paste shows plastic behaviors such as necking and pore disappearance.

For this reason, a hot gas exhaust line may be blocked at a high temperature due to rapid densification of a Cu termination electrode during the firing of the electrode, thus causing delamination faults, often called blisters.

However, the conductive paste composition for a termination electrode according to an exemplary embodiment of the present invention may prevent the occurrence of blisters and embody a thin and compact film by adding the ceramic powder, non-reactive with Cu, to the conductive metal powder 10, especially, to Cu powder.

In other words, the Cu paste including the ceramic powder added thereto according to the exemplary embodiment of the present invention exhibits pinning effects in that fine ceramic powder particles interposed between Cu particles inhibit plastic behaviors.

Also, pore disappearance over time is observed.

As such, in order to complete densification of the termination electrode after effectively discharging a hot gas, a sintering rate of Cu particles is decreased, thereby preventing blister faults.

The ceramic powder 20 may have an average particle size of 50 to 500 nm, preferably, 100 to 200 nm.

If the average particle size of the ceramic powder is less than 50 nm, it is difficult to effectively discharge the hot gas. On the other hand, when the average particle size of the ceramic powder is more than 500 nm, a degree of densification of the termination electrode may be reduced due to the large size of the ceramic particles.

The content of the ceramic powder 20 may range from 0.1 to 10 parts by weight in relation to 100 parts by weight of the conductive metal powder, preferably, 1 to 5 parts by weight.

If the content of the ceramic powder is more than 10 parts by weight, the degree of densification of the termination electrode may be reduced due to delayed sintering.

FIG. 1 is a schematic view illustrating the foregoing behaviors of the paste composition for a termination electrode according to an exemplary embodiment of the present invention.

According to the above exemplary embodiment of the present invention, the ceramic powder 20, non-reactive with Cu, is added to the conductive metal powder 10, especially Cu powder, thereby preventing the occurrence of blisters and embodying a compact and thin film.

The ceramic powder 20 is not particularly limited so long as it has favorable wettability to a dielectric layer of a multilayer ceramic capacitor and, in consideration of adhesion to a sintered element of the multilayer ceramic capacitor, is preferably the same ceramic material as the dielectric layer.

The conductive paste composition for a termination electrode according to an exemplary embodiment of the present invention may be prepared by mixing a base resin, an organic vehicle and other additives with the foregoing conductive metal powder 10 and the ceramic powder 20.

The base resin, organic vehicle and other additives described above are not particularly limited, so long as they are commonly used in preparing a conductive paste composition for a termination electrode, and the contents thereof may be varied depending upon the intended purposes of the present invention.

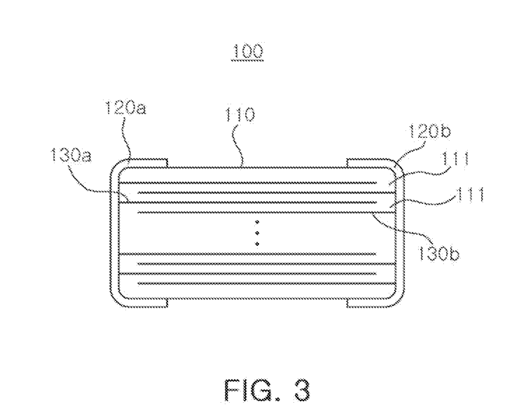

FIG. 2 is a perspective view illustrating a multilayer ceramic capacitor according to an exemplary embodiment of the present invention, and FIG. 3 is a cross-sectional view taken along line A-A′ shown in FIG. 2.

Referring to FIGS. 2 and 3, the multilayer ceramic capacitor 100 according to the exemplary embodiment of the present invention includes: a ceramic sintered body 110; a plurality of internal electrodes 130a and 130b provided in the ceramic sintered body 110, which are alternately exposed to both end surfaces of the ceramic sintered body at respective ends of the internal electrodes; and termination electrodes 120a and 120b placed on the end surfaces of the ceramic sintered body and electrically connected to the internal electrodes 130a and 130b, wherein each of the termination electrodes 120a and 120b includes 100 parts by weight of a conductive metal powder and 0.1 to 10 parts by weight of a ceramic powder having an average particle size of 50 to 500 nm.

The ceramic sintered body 110 is fabricated by laminating a plurality of ceramic dielectric layers 111 and then sintering the same, and adjacent dielectric layers are substantially integrated such that a boundary therebetween cannot be observed.

Each of the ceramic dielectric layers 111 may be made of a ceramic material having a high dielectric constant, however, the material is not limited thereto. For instance, a barium titanate (BaTiO₃) material, a lead-complex perovskite material and/or a strontium titanate (SrTiO₃) material may be used.

The internal electrodes 130a and 130b are provided on opposite sides of each dielectric layer during the lamination of plural dielectric layers as described above. More particularly, these electrode layers are formed on opposite sides of a single dielectric layer in the ceramic sintered body by sintering.

The internal electrodes 130a and 130b are paired electrodes of opposite polarity, arranged to oppose to each other in a laminating direction of the dielectric layers, and electrically insulated from each other by the dielectric layers.

The internal electrodes 130a and 130b are alternately exposed to both end surfaces of the ceramic sintered body at respective ends of the internal electrodes.

The exposed ends of the internal electrodes 130a and 130b are electrically connected to the termination electrodes 120a and 120b, respectively.

The internal electrodes 130a and 130b may be made of conductive metals. These conductive metals are not particularly limited and may include, for example, silver (Ag), lead (Pb), platinum (Pt), nickel (Ni), copper (Cu), or the like, which may be used alone or in a combination of two or more thereof.

The termination electrodes 120a and 120b are fabricated by calcination of a conductive paste for a termination electrode and the conductive paste for a termination electrode may include 100 parts by weight of a conductive metal powder and 0.1 to 10 parts by weight of a ceramic powder having an average particle size of 50 to 500 nm.

The termination electrodes 120a and 120b according to the exemplary embodiment of the present invention include the conductive metal powder, especially, Cu powder as a main ingredient, and additionally the ceramic powder having an average particle size of 50 to 500 nm in an amount of 0.1 to 10 parts by weight, in relation to 100 parts by weight of Cu, thereby exhibiting excellent densification and contact characteristics to the internal electrodes.

In general, since microfine Cu powder initiates sintering early and has a high sintering rate, it is difficult to exhaust a gas generated during the sintering of the electrodes, thus causing blister faults at a contact region between the ceramic sintered body 110 and the termination electrodes 120a and 120b.

Accordingly, the reliability of the multilayer ceramic capacitor may be deteriorated.

Since the termination electrodes 120a and 120b according to an exemplary embodiment of the present invention include microfine ceramic powder as well as the conductive metal powder, especially, Cu powder, a sintering rate of the termination electrodes is decreased while a sintering temperature is increased to smoothly discharge gas generated during sintering, thus reducing the occurrence of blisters.

Moreover, after discharging the gas, pores disappear over time, which in turn results in complete densification of the termination electrode.

Accordingly, the multiplayer ceramic capacitor according to the foregoing exemplary embodiment may have reduced blister occurrence rate and excellent densification of the termination electrodes, thus achieving a decrease in the size and an extreme increase in the capacity of the capacitor.

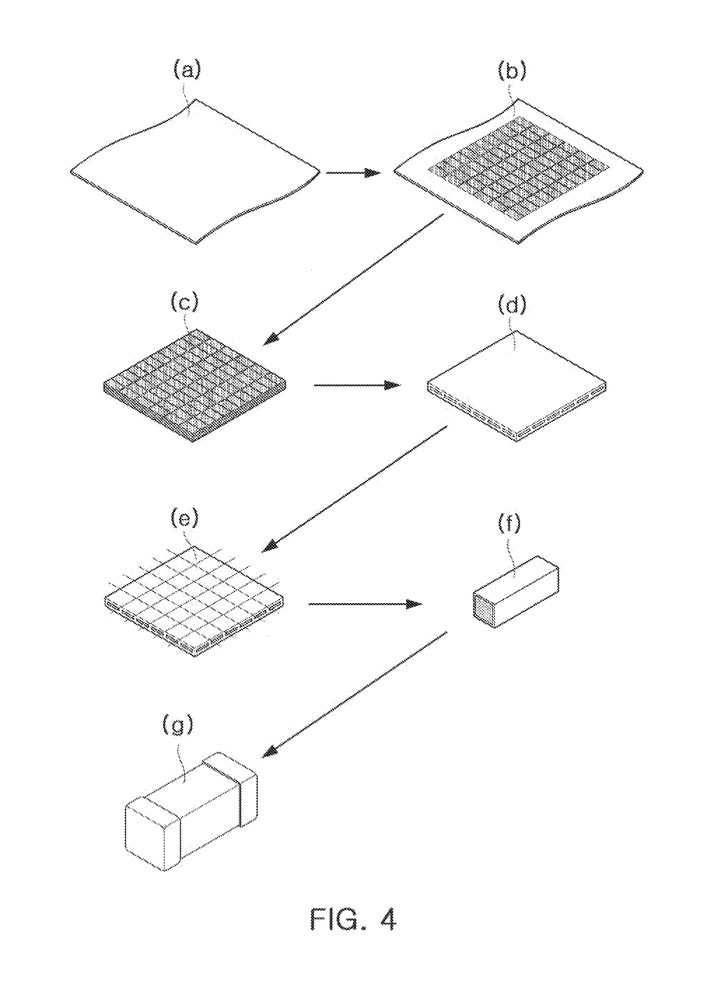

FIG. 4 illustrates a process of manufacturing a multilayer ceramic capacitor according to an exemplary embodiment of the present invention.

Referring to FIG. 4, the process of manufacturing a multilayer ceramic capacitor according to the exemplary embodiment of the present invention includes: preparing a plurality of ceramic green sheets; forming internal electrode patterns on the ceramic green sheets; laminating the ceramic green sheets having the internal electrode patterns formed thereon, in order to form a ceramic laminate; cutting the ceramic laminate to allow internal electrode patterns to be alternately exposed through the cut surfaces of the ceramic laminate at respective ends of the internal electrode patterns, then, firing the same to produce a ceramic sintered body; forming termination electrode patterns by using a conductive paste for termination electrodes which includes 100 parts by weight of a conductive metal powder and 0.1 to 10 parts by weight of a ceramic powder having an average particle size of 50 to 500 nm, such that these patterns are electrically connected to the exposed ends of the internal electrode patterns; and sintering the termination electrode patterns, thereby fabricating the termination electrodes.

The following detailed description will be given to explain each of the processes of a manufacturing method of a multilayer ceramic capacitor.

(a) First, a plurality of ceramic green sheets may be prepared.

Each of the ceramic green sheets is prepared in a sheet form having a thickness of several micrometers (μm) by blending ceramic powder with a binder and a solvent to prepare a slurry, and applying the slurry to a substrate through a doctor blade method.

(b) Then, internal electrode patterns are formed by applying an internal electrode paste to a surface of the prepared ceramic green sheet.

Such internal electrode patterns may be formed by screen printing.

The internal electrode paste used herein is prepared by dispersing Ni or Ni alloy powder in an organic binder and an organic solvent to produce a paste type product.

The organic binder used herein is any binder well known in the art without being particularly limited thereto, however, may include, for example, cellulose resin, epoxy resin, aryl resin, acryl resin, phenol-formaldehyde resin, unsaturated polyester resin, polycarbonate resin, polyamide resin, polyimide resin, alkyd resin, rosin ester, and the like.

Also, the organic solvent used herein may be any solvent well known in the art without being particularly limited thereto, however, the organic solvent may include, for example, butyl carbitol, butyl carbitol acetate, turpentine, terpineol, ethylcellosolve, butyl phthalate, and the like.

(c) Next, plural ceramic green sheets having the internal electrode patterns formed thereon are stacked one after another and pressed to allow the ceramic green sheet to be compressed with the internal electrode paste.

(d) Therefore, a ceramic laminate having the plural ceramic green sheets and the internal electrode paste alternately laminated thereupon may be fabricated.

(e) Following this, the formed ceramic laminate is cut into pieces, each of which corresponding to a single capacitor.

The cutting is carried out such that first and second internal electrode patterns are alternately exposed to the cut surfaces of the ceramic laminate at respective ends of the internal electrode patterns.

(f) Afterward, the cut laminate pieces are subjected to calcination, for example, at 1200° C. in order to fabricate a ceramic sintered body.

The ceramic sintered body is subjected to a further treatment in a barrel containing water and a polishing medium, in order to conduct surface polishing.

The surface polishing may be performed during the fabrication of the ceramic laminate.

(g) Lastly, termination electrodes are fabricated to be electrically connected to the internal electrodes exposed to both end surfaces of the ceramic sintered body.

The following description will be given to concretely explain a method of fabricating the termination electrodes.

First, a conductive paste for termination electrodes is prepared by blending the conductive metal powder 10 and the ceramic powder 20 with a base resin, an organic vehicle and other additives.

The prepared conductive paste for termination electrodes is substantially the same paste composition as described in the foregoing exemplary embodiment of the present invention.

The conductive paste for termination electrodes prepared as described above may be applied to the end surfaces of the ceramic sintered body to thereby form termination electrode patterns.

The conductive paste for termination electrodes may be sintered to thereby fabricate the termination electrodes.

The sintering of the conductive paste for a termination electrode may be conducted at 600 to 900° C.

Thereafter, a surface of each termination electrode may be subjected to plating using Ni, Sn, or the like.

In general, using the powder having a smaller average particle size may improve the contact characteristics of an internal electrode and enhance the degree of densification of the termination electrode.

However, the powder having a smaller average particle size may cause earlier sintering initiation and increase the sintering rate.

For this reason, it is difficult to exhaust gas generated at a high temperature, in turn causing blister faults, that is, delamination between the ceramic sintered body and the termination electrode.

Due to the blister faults, the reliability of the multilayer ceramic capacitor may be deteriorated.

However, according to the exemplary embodiment of the present invention, the occurrence of blisters may be prevented by adding the ceramic powder, non-reactive with Cu, to the conductive metal powder during preparing the paste for a termination electrode.

More particularly, the Cu paste containing the ceramic powder added thereto exhibits pinning effects in that microfine ceramic powder particles inserted between Cu particles inhibit plastic behaviors.

Moreover, the Cu paste exhibits a behavior in that pores are disappeared over time.

After effectively discharging the hot gas, reducing a sintering rate of Cu particles may complete densification of the termination electrode, thereby preventing blister faults.

The multilayer ceramic capacitor fabricated by the manufacturing method according to the exemplary embodiment of the present invention may have reduced blisters and excellent densification of the termination electrode, thereby achieving a decrease in the size and an increase in the capacity of the capacitor.

The average particle size of the ceramic powder may range from 50 to 500 nm, preferably, 100 to 200 nm.

If the average particle size of the ceramic powder is less than 50 nm, it is difficult to effectively discharge the hot gas. On the other hand, when the average particle size of the ceramic powder is more than 500 nm, a degree of densification of the termination electrode may be reduced due to the large ceramic particles.

The content of the ceramic powder may range from 0.1 to 10 parts by weight in relation to 100 parts by weight of the conductive metal powder, preferably, 1 to 5 parts by weight.

If the content of the ceramic powder is more than 10 parts by weight, the degree of densification of the termination electrode may be reduced due to delayed sintering.

Hereinafter, the present invention will be described in detail with reference to the following inventive examples and comparative example, however, the scope of the present invention should not be construed as limited thereto.

### Examples 1 to 5

In these examples, Cu powder as a main ingredient and ceramic powder having an average particle size of 150 nm in predetermined amounts of 1 part by weight (Example 1), 2 parts by weight (Example 2), 3 parts by weight (Example 3), 4 parts by weight (Example 4) and 5 parts by weight (Example 5), respectively, in relation to 100 parts by weight of Cu powder, were prepared and mixed together. Then, a base resin, a dispersant and an organic solvent were added to each of the mixtures. The obtained mixture was subjected to dispersion using a 3-roll mill to prepare a paste.

### Comparative Example

Comparing to the foregoing inventive examples 1 to 5, a comparative example was fabricated by the same procedures as described in the inventive examples except that the ceramic powder was not added.

For each of samples obtained from the foregoing inventive examples and the comparative example, the occurrence of blisters and a microfine structure of the termination electrode after calcination of the electrode were investigated.

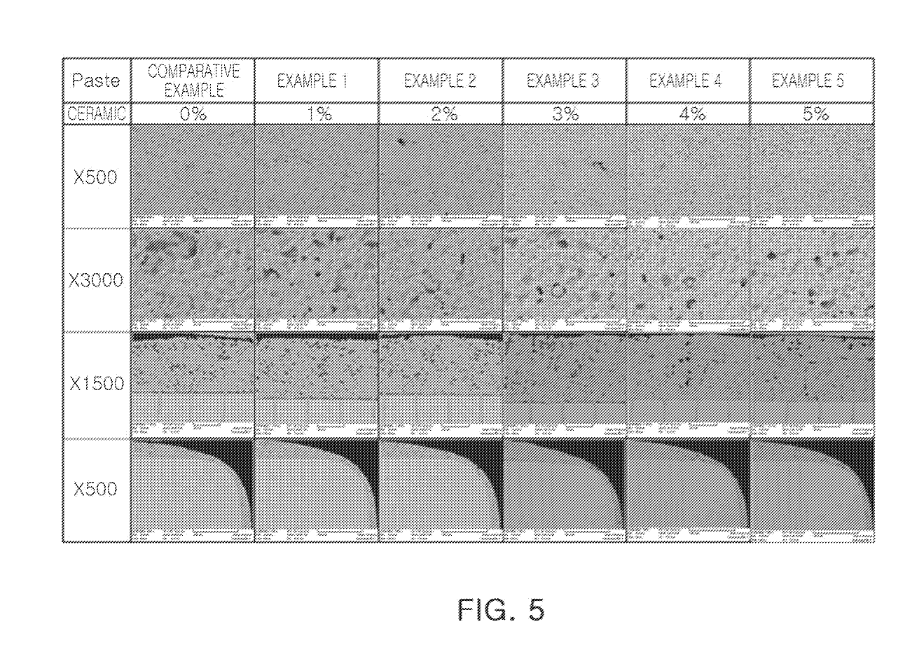

FIG. 5 is electron micrographs showing the microfine structures of the termination electrodes according to the inventive examples and the comparative example.

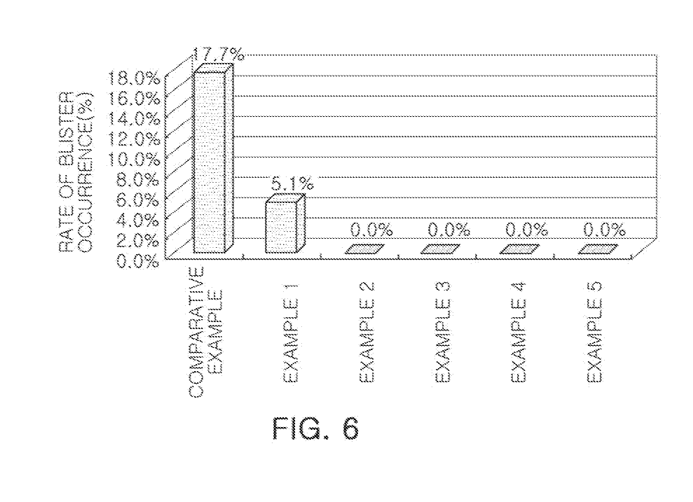

In addition, FIG. 6 is graphs showing the blister occurrence rate according to the inventive examples and the comparative Example.

From analysis results of the microfine structures shown in FIG. 5, it can be seen that the termination electrodes according to Examples 1 to 3 have substantially similar final degree of densification, whereas the termination electrodes according to Examples 4 and 5 exhibit deteriorated densification due to delayed sintering of the Cu powder caused by addition of the ceramic powder.

From the analysis results of the blister occurrence rate shown in FIG. 6, it can be seen that the termination electrode according to the Comparative Example has a blister occurrence rate of 17.7% after completing calcination of the electrode.

On the other hand, the termination electrode including 1 part by weight of the ceramic powder according to Example 1 showed a reduced blister occurrence rate to 5.1%, while the termination electrodes including at least 2 parts by weight of the ceramic powder according to Examples 2 to 5 did not exhibit blisters.

Consequently, since the multilayer ceramic capacitor according to an exemplary embodiment of the present invention has a termination electrode fabricated by using a paste for a termination electrode, which includes the ceramic powder as well as the conductive metal powder, the capacitor may have reduced occurrence of blisters and excellent densification of the termination electrode, and may achieve a reduction in the size and an increase in the capacity of the capacitor.

As described above, the conductive paste for a termination electrode according to the present invention may have a high firing density even in the case that it is used in the manufacturing of a thin film, and inhibit the occurrence of blisters, a delamination failure in the termination electrode during calcination of the electrode, thereby producing a compact and thin film.

Consequently, even when a thin film type termination electrode is fabricated, a compact and thin film may be produced, thereby attaining excellent effects to achieve a reduction in the size and increase in the capacity of a multilayer ceramic capacitor.

While the present invention has been shown and described in connection with the exemplary embodiments, it will be apparent to those skilled in the art that modifications and variations can be made without departing from the spirit and scope of the invention as defined by the appended claims.

What is claimed is:

1. A conductive paste composition for a termination electrode, the conductive paste composition comprising:
100 parts by weight of a conductive metal powder; and
0.1 to 10 parts by weight of a ceramic powder having an average particle size of 50 to 500 nm.

2. The conductive paste composition of claim 1, wherein the conductive metal powder is copper (Cu).

3. The conductive paste composition of claim 1, wherein an average particle size of the conductive metal powder ranges from 0.1 to 4 μM.

4. The conductive paste composition of claim 1, wherein the average particle size of the ceramic powder ranges from 100 to 200 nm.

5. The conductive paste composition of claim 1, wherein a content of the ceramic powder ranges from 1 to 5 parts by weight.

6. A multilayer ceramic capacitor comprising:
a ceramic sintered body;
a plurality of internal electrodes provided in the ceramic sintered body, which are alternately exposed to both end surfaces of the ceramic sintered body at respective ends of the internal electrodes; and
termination electrodes placed on the end surfaces of the ceramic sintered body and electrically connected to the internal electrodes,
wherein each of the termination electrodes includes 100 parts by weight of a conductive metal powder and 0.1 to 10 parts by weight of a ceramic powder having an average particle size of 50 to 500 nm.

7. The multilayer ceramic capacitor of claim 6, wherein the conductive metal powder is copper (Cu).

8. A method of manufacturing a multilayer ceramic capacitor, the method comprising:
preparing a plurality of ceramic green sheets;
forming internal electrode patterns on the ceramic green sheets;
laminating the ceramic green sheets having the internal electrode patterns formed thereon, to thereby form a ceramic laminate;
cutting the ceramic laminate to allow the internal electrode patterns to be alternately exposed to the cut surfaces of the ceramic laminate at respective ends of the internal electrode patterns, then, firing the same to thereby produce a ceramic sintered body;
forming termination electrode patterns by using a conductive paste composition for termination electrodes, which includes 100 parts by weight of a conductive metal powder and 0.1 to 10 parts by weight of a ceramic powder having an average particle size of 50 to 500 nm, such that the termination electrode patterns are electrically connected to the exposed ends of the internal electrode patterns; and
sintering the termination electrode patterns to thereby fabricate termination electrodes.

9. The method of claim 8, wherein the sintering of the termination electrode patterns is conducted at 600 to 900° C.

10. The method of claim 8, wherein the conductive metal powder is Cu.

11. The method of claim 8, wherein an average particle size of the conductive metal powder ranges from 0.1 to 4 μM.

12. The method of claim 8, wherein the average particle size of the ceramic powder ranges from 100 to 200 nm.

13. The method of claim 8, wherein a content of the ceramic powder ranges from 1 to 5 parts by weight.
